(19) United States
(12) Patent Application Publication
(10) Pub. No.: US 2009/0154789 A1
(43) Pub. Date: Jun. 18, 2009

(54) SYSTEM AND METHOD FOR DETECTING OPTICAL DEFECTS

(75) Inventor: Gregory Adam Wolfe, Huntington Beach, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: GRADIENCE IMAGING, INC., Temecula, CA (US)

(21) Appl. No.: 12/210,948

(22) Filed: Sep. 15, 2008

Related U.S. Application Data
(60) Provisional application No. 61/014,337, filed on Dec. 17, 2007.

(51) Int. Cl. G06K 9/00

(52) U.S. Cl. 382/141

(57) ABSTRACT

A system and method for detecting optical defects on a surface of a transparent or semi-transparent structure, tube or article is provided. Defects are identified and analyzed by using a digital camera to capture an image of a target having a pattern of light and dark areas through a portion of the article. The images are processed to enhance the visibility of the defects, and the distribution of the defects as function of their location on the surface of the article is determined. This determination is used as part of a statistical process control method for controlling the level of defects present on the surface of the article.

### CROSS-REFERENCES TO RELATED APPLICATIONS

This application claims priority from U.S. Provisional Application No. 61/014,337, filed Dec. 17, 2007, incorporated by reference in its entirety.

### BACKGROUND

This invention relates to inspection systems for characterizing the distribution of lubricating fluids applied to tubular barrels, and more particularly, to determining the consistency of distribution of lubricating fluid within a syringe for predicting the probability that incomplete ejection of the contents of the syringe will occur upon injection due to stalling of the plunger of the injector during injection.

Use of pre-filled syringes in combination with auto-injectors is rapidly becoming a standard method of drug delivery. In such a system, a syringe is pre-filled with a drug to be delivered, and then may be stored for a period of time before use. The pre-filled syringe is then placed in an auto-injector, which, when activated, applies force to the plunger of the syringe to expel the contents of the syringe. Because of the relatively tight fit of the plunger to the inner diameter of the barrel of the syringe to prevent leakage of the drug during storage, it has been found to be necessary to apply a lubricant to the inner wall of the syringe barrel to ensure that the plunger does not stick to the barrel during the injection process.

The syringes are typically filled with a specific amount of drug that corresponds to a standard dosage of the drug that will be delivered to a patient. When the plunger sticks in the barrel of the syringe, the entire dose of the drug is not injected into the patient. This is problematic because it will be difficult to correlate the response of the patient to the drug with the dosage given. In some cases, the under dose may be so severe as to provide little or no medication to the patient. While such under medication may be observed and corrected by the care giver providing the injection, it is inconvenient and requires giving partial dosages from another syringe, which may be difficult to accomplish, and is also costly because it results in wasted drug. Where the drug is administered by the patient, incomplete injection may not even be noticed by the patient. Even if noticed, the patient may choose to do nothing, or at most, may call his or her physician, pharmacist, or manufacturer of the drug product to complain about the malfunction of the syringe.

One method of providing lubrication to the barrel of the syringe is to apply a coating of silicone oil. Silicone oil is generally sprayed into the barrel of the syringe by inserting a sprayer nozzle into the barrel, with the oil being emitted from the orifices at the distal end of the nozzle. Depending on the length of the syringe barrel, the nozzle may be inserted deep into the syringe, spraying activated, and then the nozzle is backed out of the syringe barrel to coat the entire barrel. The objective of such systems is to apply a consistent layer of silicone oil along the entire length and circumference of the syringe barrel.

However, due to locating problems, nozzle inconsistencies, or inconsistency in the pressure used to spray the silicone oil into the syringe, the distribution of the silicone oil within the barrel may vary along the length and/or circumference of the barrel. Additionally, this inconsistency can be exacerbated during storage of the pre-filled syringe, since the hydrophobic silicone oil tends to bead up when placed in contact with an aqueous solution. For these reasons, various methods have been developed to assess the distribution of silicone oil to attempt to determine the likelihood that a syringe will be subject to incomplete injection.

Unfortunately, the current methods of assessing silicone oil distribution cannot be directly correlated to injection performance. Additionally, such methods are typically destructive in nature, time consuming, and/or expensive.

What has been needed, and heretofore unavailable, is an efficient and accurate non-destructive testing and inspection method that can quantitatively determine the presence or absence of silicone oil in the syringe, and also the distribution of silicone oil within an empty or pre-filled syringe and, using appropriate analysis techniques, estimate a probability that the injector will be subject to incomplete injection, and, if the probability exceeds a predetermined threshold probability, provide an indication to a user of the method that the syringe is likely to fail. The present invention satisfies these, and other needs.

### SUMMARY OF THE INVENTION

The various aspects of the systems and methods of the present invention provide for non-destructive inspection of the transparent or semi-transparent articles or structures to identify the presence or absence of defects or additives on a selected surface of the article or structure, and if present, provide for analyzing an image of the defect or additive and subsequent analysis to determine a distribution of the defect or additive. Such analysis is useful in projecting, for example, when a syringe with an inadequate coating of a lubricant, such as silicone oil, will fail to inject its entire contents of drug due to the plunger of the syringe stalling in the syringe.

In one aspect, the invention includes an inspection system for monitoring the distribution of an additive on the inner surface of the barrel of a syringe, comprising: a target having a pattern of alternating light and dark areas; a camera in optical alignment with the target; a syringe holder for holding a syringe at a desired location between the camera and the target; and, a light source for illuminating the target to enable the camera to capture an image of the target through the syringe. In a further aspect, the camera is a digital camera, and the system also includes a processor and a memory in communication with the digital camera, the memory storing images received from the camera under control of the processor. In a still further aspect, the processor is programmed to receive images from the camera, store the images in the memory, and processes the images to detect the presence of an additive on a portion of an inner wall of the syringe.

In another aspect, the syringe holder of the inspection system is configured to provide for rotation of the syringe. In yet another aspect, the syringe holder is movably mounted with respect to the target and the camera to provide for translational of the syringe in a direction normal to an alignment axis of the camera and target.

In a still further aspect, the light source is positioned behind the target and so that light is transmitted through the light areas of the target towards the camera. In yet another aspect, the light source illuminates a front side of the target such that light illuminating the target is directed towards the camera.

In still another aspect, the processor is further programmed to determine a distribution of the additive as a function of location on the inner wall of the syringe. In another aspect, the processor is further programmed to analyze the distribution of the additive as a function of location on the inner wall of the syringe and provide a value representative of the distribution and to determine if the value falls within a range of values representing an acceptable distribution of additive on the inner wall of the syringe.

In another aspect, the invention provides a method for inspecting an article to determine if a surface of the article has an acceptable condition, comprising: placing the article in a fixture located between a target and a camera; acquiring an image by the camera of the target through the article; processing the image of the target to determine if any defects associated with a selected surface of the article are present; analyzing the image to determine the distribution of defects associated with the selected surface of the article; and rejecting the article if the distribution of defects associated with the selected surface of the article is determined to be unacceptable. A further aspect includes storing the acquired image in a memory. Still another aspect further includes acquiring a first image by the camera of the target through the article; storing the first image in the memory; moving the article a selected amount; acquiring a second image by the camera of the target through the article; storing the second image in the memory; processing the first and second images stored in the memory to provide a composite image of the surface of the article.

A still further aspect includes translating the article along an axis transverse to an axis defined by the camera and the target; acquiring a third image by the camera of the target through the article; storing the third image in the memory; processing the first, second and third images stored in the memory to provide a composite image of the surface of the article.

Still another aspect of the invention includes a system for determining the distribution of silicone oil on selected surface of an article, comprising: a target having a pattern of alternating light and dark areas; a light source positioned behind the target; a digital camera positioned to receive light transmitted through the target from the light source; an article holder for holding an article at a desired location between the camera and the target such that light transmitted through the target from the light source passes through article to the camera; and a memory in communication with the camera for storing images from the camera produced by the light passing through the article. In still another aspect, the article holder is moveable to allow movement of the article relative to an optical path defined by the camera and the target.

A still further aspect includes a processor in communication with the camera and the memory, the processor programmed to control the storage of images from the camera in the memory, to process the images in the memory, and to analyze the processed images to determine a distribution of silicone oil on a selected surface of the article. In yet another aspect, the processor is also programmed to provide an indication to a user of the acceptability of the distribution of silicone oil on the selected surface of the article.

In still another aspect, the article being imaged has a lumen defined by an inner wall. In yet another aspect, the article is selected from the group consisting of a vial, a tube, an ampule, or a syringe. In another aspect, the article may be ovoid, cylindrical, flat, oblate or any other shape that has a surface that requires inspection, provided the article is transparent or semi-transparent.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a side view of one embodiment of an inspection system in accordance with the principles of the present invention.

FIG. 2 is a front view of filter plate having alternating dark and light lines disposed thereon.

FIG. 3 is a diagram showing how light passing through a syringe is refracted in such a manner so that only a portion of the syringe wall is observed.

FIG. 4 is an image showing how the pattern of light and dark areas of the filter of FIG. 2 enhances the visibility of silicone oil on an inner wall of a syringe.

FIG. 5 is a computer generated image derived from an image in accordance with FIG. 4 showing individual droplets or groups of droplets of silicone oil present on an inner wall of a syringe.

FIG. 6 is a computer generated image representing further processing of the image of FIG. 5 to identify the boundaries of the droplets to allow the area of the droplets or groups of droplets to be determined.

FIG. 7A is a graphical representation of data generated using one embodiment of the system of the present invention illustrating an unacceptable distribution of silicone oil in a syringe as a function of barrel radial and length position, showing too little silicone oil at a location adjacent the outlet port of the syringe.

FIG. 7B is a graphical representation of data generated using one embodiment of the system of the present invention illustrating an acceptable distribution of silicone oil in a syringe as a function of barrel radial and length position, showing increased amounts of silicone oil at a location adjacent the outlet port of the syringe compared to the syringe of FIG. 7A.

### DETAILED DESCRIPTION OF THE PREFERRED EMBODIMENTS

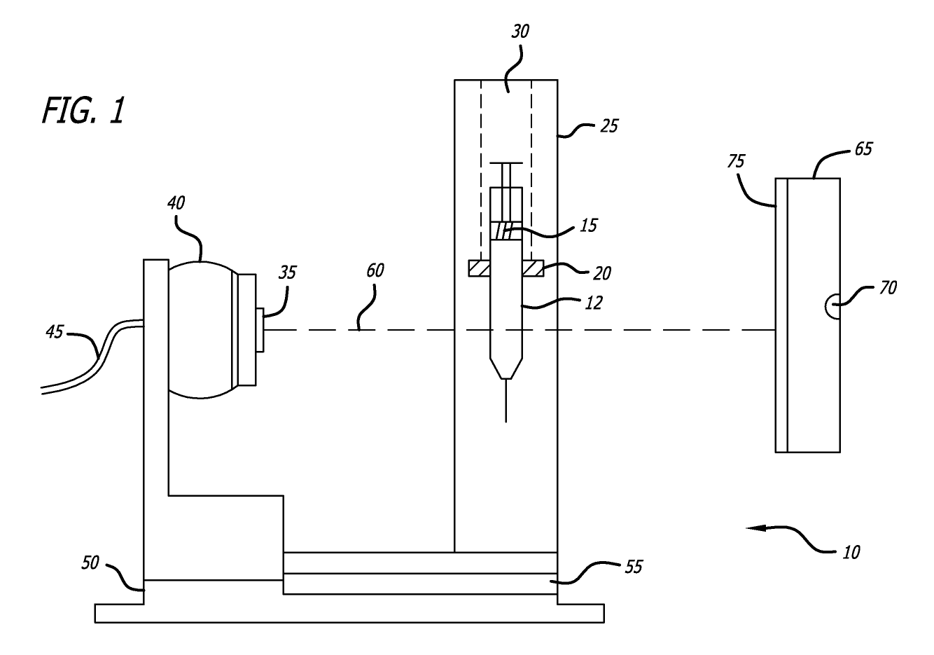

Referring now to the drawings in detail, in which like reference numerals indicate like or corresponding elements among the several figures, there is shown in FIG. 1 a front view of one embodiment of an inspection system 10 in accordance with principles of the present invention.

Inspection system 10 is an optical inspection system, and thus the components of the system to be described in more detail below will be understood to be mounted in such a way as to provide adjustment and movement of the various components so that an appropriate optical focus for the light passing through the components can be obtained. In this embodiment, a pre-filled syringe 12 having a plunger 15 is moveably mounted via a rotatable collar 20 to a mounting plate 25. Collar 20 is mounted to plate 25 via translating means 30 so that collar 20 can be translated upwards and downwards along the length of plate 25. Those skilled in the art will understand that this translation can be accomplished in a variety of ways typically used to move components in an accurate manner. For example, plate 25 and collar 20 may be configured using a dovetail arrangement typically used to position optical components so that the components can be moved in a precise manner. Rotatable collar provides for rotation of the syringe 12 in relation to the plate 25 to allow the entire circumference of the syringe to be scanned as will be described below.

Typically, syringe 12 is held within collar 20 by clamping around the outer diameter of the barrel of the syringe. In an alternative embodiment, the syringe may be held by inserting a variable size clamping mechanism into the barrel of a syringe that does not have a plunger in place within the barrel of the syringe or has a plunger that is positioned below the area where the clamping takes place. In this embodiment, the variable size clamping mechanism has a first size that is smaller than the inner diameter of the syringe barrel. Once the variable size clamping mechanism is inserted into the barrel of the syringe, the variable size clamping mechanism is actuated to attain a second size that is just large enough to engage the inner wall of the barrel to hold the barrel in place for inspection. For example, variable size clamping mechanism may have a pair of levers or jaws that can expand to hold the syringe in place. Alternatively, collar 20 may be configured to provide an interference fit with a syringe, eliminating the need to clamp the syringe in collar 20. Similarly, a tapered pin, or a pin formed from a compressible material, may be inserted into the barrel of the syringe to engage the inner wall of the barrel to hold the barrel in place. Each of these embodiments allows both rotation of the syringe and transverse movement of the syringe relative to the optical axis 60.

Inspection system 10 also includes a digital camera 35, which may be a charge coupled device (CCD) camera. Such cameras are capable of viewing an object with high resolution and providing a digital signal representative of the image falling on the camera to a processor or other analyzing device for subsequent processing and/or analysis. Alternatively, the camera may also be a CMOS (complementary metal oxide semiconductor) camera.

Camera 35 is mounted in a housing 40, which may also include various means for adjusting the location of the camera to align the camera along a desired axis, and also to place the camera in a location at a desired focus point to provide a high resolution image of a selected portion of an inner wall of the syringe. A cable or wire 45 provides for communication of the signal produced by the CCD camera to a computer or processor for further processing. Housing 40 is moveably mounted to base plate 50, which includes a translation means 55 for moving the housing 40 laterally along the base plate 50. This lateral motion provides a way to locate and focus the camera 35 at a desired point.

Also included in this embodiment of inspection system 10 is a target 65. Target 65, in this embodiment, includes a light source 70 that provides light that is shown through filter 75. The light produced by light source 70 is diffused by filter 75 so that light from light source 70, which can be generalized, for convenience of this description, as consisting of generally parallel rays of light (although, as those skilled in art will immediately understand, the rays are not actually parallel, and are emitted from the light source at all angles), is emitted from filter 75 and travels along optical path 60 through the syringe and into the lens of camera 35.

While not shown for simplicity, it will be understood that target 65 is adjustably mounted to the same support structure as are camera 35 and syringe 12. This allows the location and orientation of target 65 to be adjusted as needed relative to the positions of syringe 12 and camera 65 so that the optical performance of the entire system can be optimized.

In an alternative embodiment, target 65 does not include light source 70 that provides backlighting to filter 75. In this embodiment, a separate light source mounted external to target 65 is positioned to illuminate target 65 from the front, with the light source positioned so that light rays from the light source fall upon the target at an angle in the range of 90 degrees to minus 90 degrees, relative to the target 65. In this embodiment, filter 70 is replaced by a target comprised of light and dark alternating portions disposed on a non-transparent background. In alternative embodiments, target 65 may have any combination of alternating dark and light areas, provided that the darker and lighter areas of the alternating pattern provide a suitable contrast difference. For example, the pattern could be composed of alternating areas of differing colors or shades of gray.

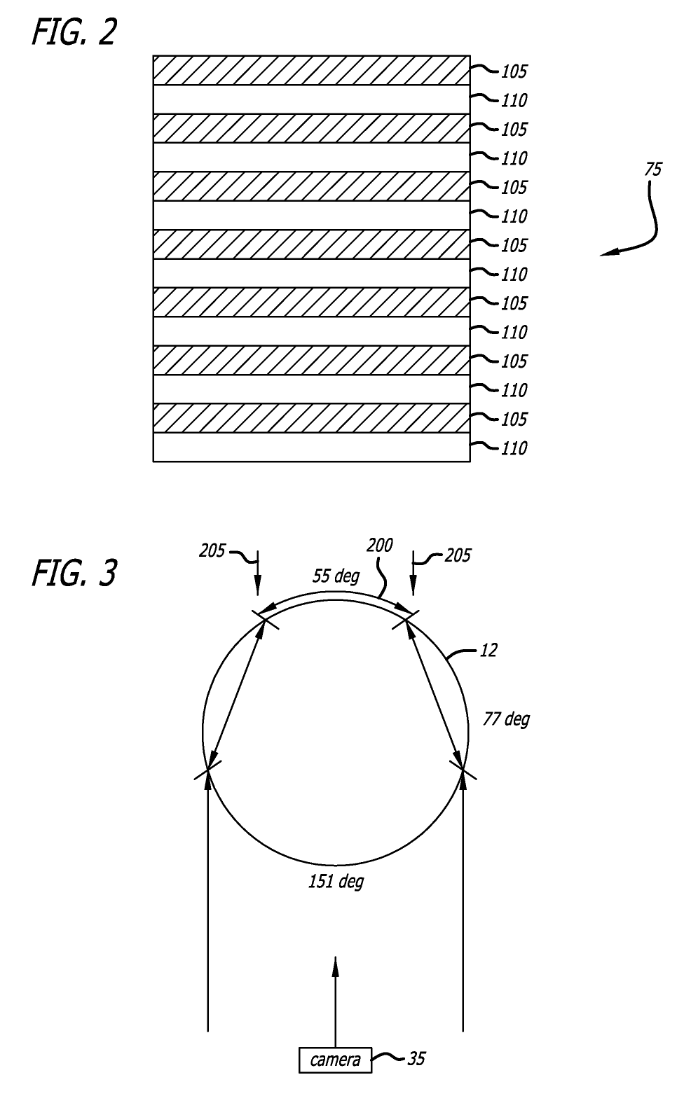

FIG. 2 is a graphical representation of a front view of filter 75 of target 65. As shown in this exemplary embodiment, filter 75 has dark areas 105 alternating with light areas 110. In the embodiment shown with reference to FIG. 1, light areas 110 must be capable of transmitting at least a portion of the light from light source 70 through filter 75 so that light being transmitted through light areas 110 passes along optical axis 60 through syringe 12 and into camera 35. In the embodiment where the light source is positioned in front of target 65 so that light falls upon the front surface of the target, there is no need for the light areas 110 to be capable of transmitting light. Instead, light from the side positioned light source is reflected by light areas 110 through syringe 12 and into camera 35.

In one embodiment wherein filter 75 is lighted from the back by light source 70, and light areas 110 transmit light through filter 70 to the camera 35, the filter 75 is sized so that the length and width exceed the length and width of the area of the syringe intended to be inspected. This ensures that the alternating pattern of light and dark areas covers the entire intended inspection area of the syringe. In this embodiment, the width of light area 110 is approximately 0.01 mm to 10 mm, and preferably 1.0 mm, and the width of dark area 105 is approximately 0.01 mm to 10 mm, and preferably 1.0 mm.

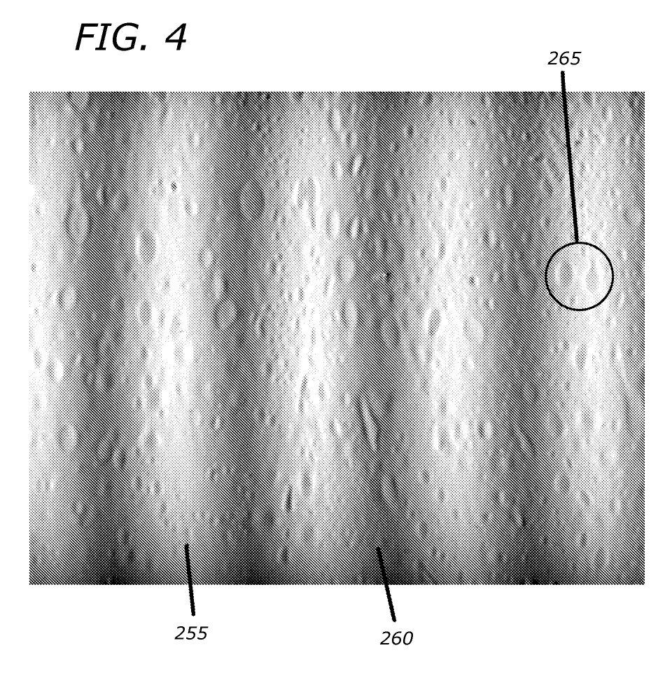

In use, the camera 35 of inspection system 10 is aligned with target 65 so that the lens of camera 35 is focused on the back wall of syringe 12, as shown in the diagram of FIG. 3. This image is a top view looking down through syringe 12, and shows light rays 205 being refracted as they pass through the wall of syringe 12. It has been determined that, given the relative dimensions of syringe 12, including its curvature, and the typical refractive indices of the glass of syringe 12 and the contents, if any, of syringe 12, camera 35 is capable of reliably capturing the image of a section of the back wall of syringe 12 that includes an arc of approximately 45 to 65 degrees, and preferably 55 degrees. Those skilled in the art will understand that this arc may vary somewhat depending on the size, thickness, curvature and refractive index of the glass of the syringe, as well as the contents, if any, of the syringe, without departing from inclusion within the intended scope of the invention.

Since the arc of best focus for the exemplary embodiment of inspection system 10 shown in FIG. 1 is approximately 55 degrees, it is necessary to rotate syringe 12 during inspection to ensure that the entire inner surface of syringe 12 is inspected. Accordingly, syringe 12 is rotated 55 degrees and an image taken by camera 35 after the initial image is stored. This process is repeated until the entire circumference of the inner wall of syringe 12 is imaged.

In another embodiment of the invention, rather than viewing a back wall portion of the syringe, a prism may be placed between the camera and the syringe. The prism magnifies the image of the syringe, allowing for a portion of the inner wall of the syringe closest to the camera, which will be considered the front wall of the syringe, for the purposes of this description, to be imaged. Such an arrangement would also require the syringe to be rotated or translated in a transverse direction relative to the optical axis to ensure that the entire inner wall of the syringe is imaged by the camera.

In yet another embodiment, additives such as silicone oil present on the inner wall of a syringe closest to the camera can be imaged without the aid of a prism located between the camera and the syringe. However, this setup does not magnify the appearance of the silicone oil on the inner wall of the syringe, and while an image taken with this setup can be used for later analysis, as will be discussed in more detail below, is not as accurate. However, this arrangement does provide a larger filed of view of the inspection area of the syringe, and may reduce the number of images required to image and analyze the entire barrel of the syringe.

Rotating collar 20, and also the other exemplary embodiments described above, in which the syringe 12 is mounted, can be actuated either manually, or it can be turned under computer control using an appropriate computer controlled actuator. In this manner, the syringe may be accurately rotated during inspection so that each image may be then combined with accurate indexing of each frame so as to provide a single integrated image of the inner circumference of the syringe. Because the various images are stored in a memory associated with the camera and image processing hardware and software, the image may be displayed on a screen. It may also be manipulated for viewing by an operator using computer controls. Alternatively, the syringe may be viewed simply by directing the real-time image from the camera to the viewing screen, and rotating the syringe either manually or by remote or computer control.

In an alternative embodiment, rotating collar 20 may either be replaced by, or supplemented by, a movable holder that provides for movement of the syringe relative to the optical axis defined by the camera and target to ensure that the entire width of the syringe, or other article being inspected, may be imaged. Typically, the movable holder will move in a direction transverse to the optical axis so that particularly wide articles may be imaged by sequentially imaging selected portions of the width of the article.

In some cases, it may also be necessary to translate the syringe in a direction transverse to the optical axis to ensure that the entire length of the syringe or article being inspected can be imaged. Depending on the length of the syringe, such translation may need to be accomplished in a number of increments. Each time the location of the syringe is incremented, the syringe must then be rotated as described above to image the entire circumference of the inner wall of the syringe. All of these images may then be combined using a processor, memory and software as described below to produce a composite image of the syringe.

Once all of the images for a given syringe are captured by the camera and stored in an associated memory, the images may be processed by the processor in various ways to improve the accuracy of subsequent analysis. For example, in one embodiment, the processor may process the images to flatten the images to compensate for the curvature of the images due to the curvature of the syringe to reduce distortion of the shapes and sizes of defects and additives, such as silicone oil, present on the inner surface of the syringe.

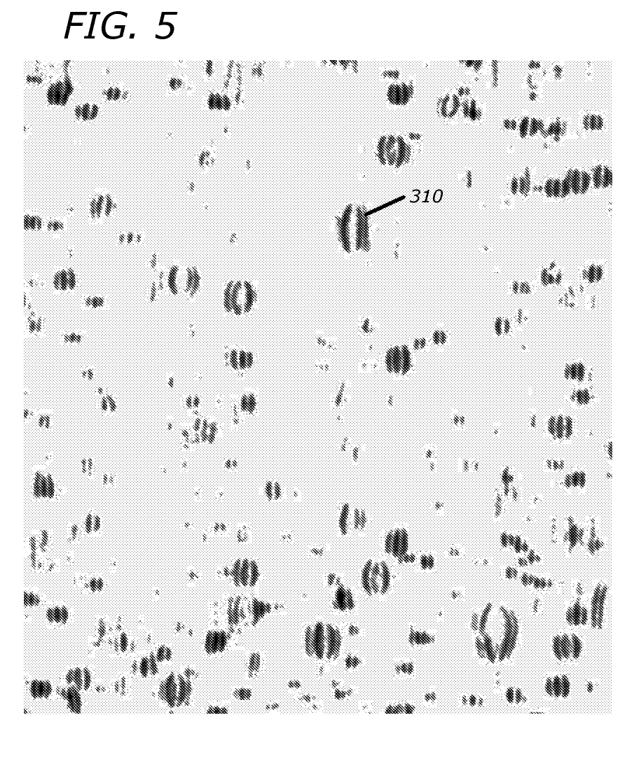

FIG. 4 is an image taken by camera 35 (FIG. 1) showing a view looking through the syringe and illustrating the presence of droplets of silicone oil on the inner wall of the syringe. As stated previously, this view shows approximately 55 degrees of the curvature of the inner wall of the syringe. In this image, light areas 255 and dark areas 260 are clearly visible. Circle 265 is used to point out droplets of silicone oil present on the inner wall of the syringe. The inventors have found that using the alternating pattern of light areas 255 and dark areas 260 enhance the contrast of resolution of the images of the droplets, and that without the alternating pattern of light and dark areas, the droplets would, at best, be poorly visible.

Use of the alternating light and dark areas, however, enhances the visibility of the droplets of silicone oil area to the extent that the images may be processed using image processing software to not only identify and further enhance the images of the silicone droplets, but also allows the use of machine vision software, such as, for example, software based on the DVT/Cognex or Siemens platforms, to identify individual droplets, calculate their area, and then calculate a value for area of coverage of the inner wall of the syringe by the droplets. Using this value, a determination can be made whether there is enough silicone oil present on the inner wall of the syringe to facilitate complete injection of the contents of the syringe, or whether the plunger of the syringe will hang up at some location inside the syringe, resulting in incomplete injection of the contents of the syringe.

Further, the images may be analyzed to determine the existence of dry areas where there is insufficient or no silicone oil present. Such an analysis provides further information regarding the uniformity of silicone oil distribution on the inner surface of the syringe, and can also be useful in projecting the ultimate performance of the syringe.

While it is possible to use off-the-shelf machine vision software capable of operating on various operating platforms, such as Windows by Microsoft, or Linux by Redhat, custom designed programs derived from, for example, the DVT/Cognex or Siemens platforms may also be used, depending on the needs of the particular inspection to be carried out, without departing from the scope of the invention.

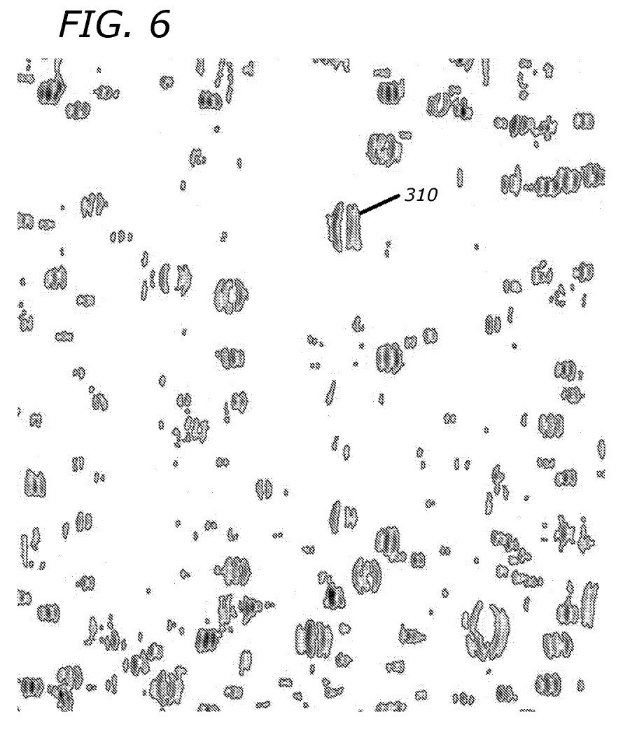

FIG. 5 illustrates one embodiment of the present invention using machine vision analysis techniques to identify and measure individual oil droplets from images provided by the inspection system 10 of FIG. 1. The image illustrated by FIG. 5 is taken from an image similar to that shown in FIG. 4. In the first step of analysis, the image processing software digitally removes the alternating pattern of light and dark areas from the image, leaving only images of the individual droplets or groups of droplets. In its simplest form, the digital subtraction of the background is carried out on a control image of the alternating pattern of light and dark areas taken by imaging a syringe with no silicone oil present, and then digitally subtracting the control image from an image where silicone oil droplets are present, leaving the image of FIG. 5. Users of Photoshop by Adobe and other such programs, as well as users of machine vision software tools such as DVT Intellect will be very familiar with such an image enhancement method to reduce noise and other unwanted artifacts. Still other techniques, such as, for example, using filter tools to filter out objects in the background of the image that are not identified or outlined as defects or silicone oil droplets, can be used to accomplish this digital subtraction and are well known in the art, and will not be described in detail here.

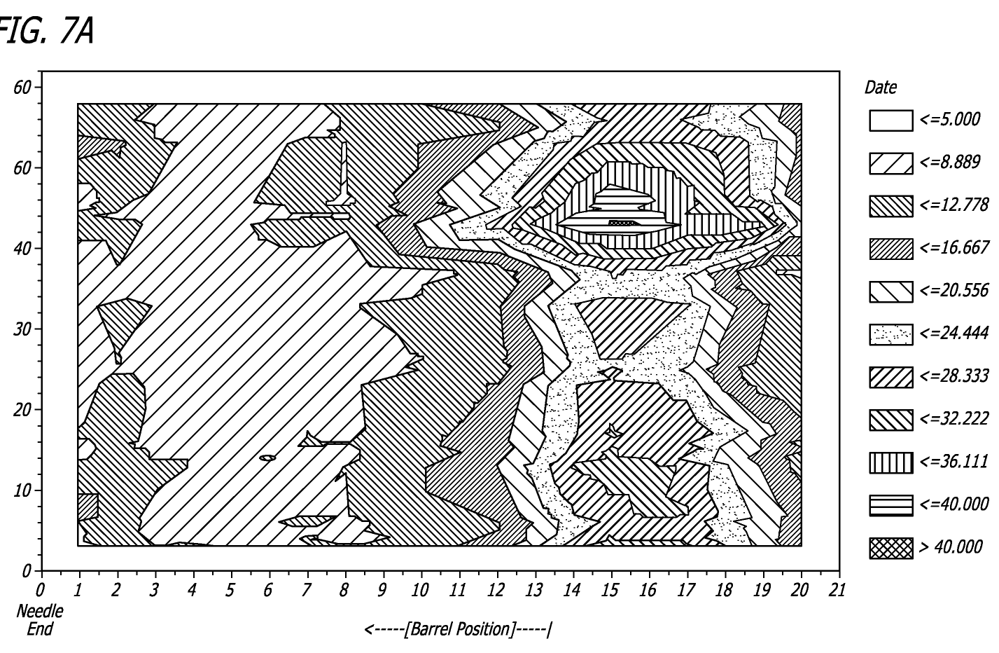

Once the individual silicone oil droplets are identified, appropriate software may be used to determine the size and area of the individual droplets or groups of droplets. FIG. 6 shows the result of using a software program designed to determine the edges of the droplets. Comparing FIG. 5 to FIG. 6, droplets 310 are shown in FIG. 5, but in FIG. 6 can be seen to be outlined by a black boarder. The black border represents the edge of the droplet as determined by the software program.

Once the edge of the droplet has been determined, the software can then calculate the area covered by the black border or can also integrate over the width and height of the droplet to determine the area of the droplet. When the areas of the silicone droplets are determined, further analysis can be done to determine the percentage of the area of the inner circumference of the syringe that is covered by silicone oil. Additionally, because the area of each droplet has been determined, the uniformity of the distribution of the silicone oil as a function of both circumference, and along the length of the syringe barrel, may also be determined.

Additional statistical analysis can be accomplished by dividing the imaged area of the syringe into a matrix of areas having a predetermined size. The relative incidence of silicone oil droplets, as well as their areas, can then be analyzed as a function of their location in the matrix to determine if any particular areas of the syringe are more prone to aggregation of the silicone oil, or to an absence of the silicone oil.

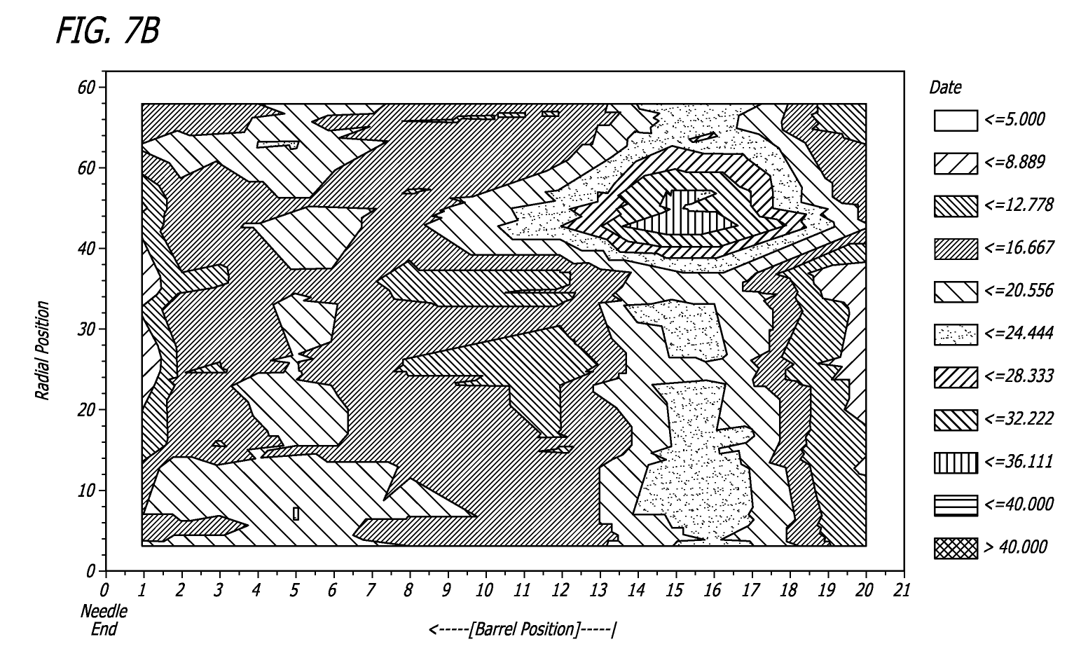

FIG. 7A is a graphical representation of data generated using one embodiment of the system of the present invention illustrating an unacceptable distribution of silicone oil in a syringe as a function of radial and barrel position, showing too little silicone oil at a location adjacent the outlet port of the syringe. FIG. 7B is a similar graphical representation of data illustrating an acceptable distribution of silicone oil in a syringe as a function of radial and barrel position, showing increased amounts of silicone oil at a location adjacent the outlet port of the syringe compared to the syringe of FIG. 7A. Such distributions can be used to project the probability that a plunger will stall when the syringe is placed in an auto-injector, resulting in incomplete injection of the contents of the syringe.

All of the image processing and statistical analysis can be used with well know statistical process control (SPC) methods for quality assurance and lot release for incoming syringes prior to filling, second source validation for ensuring that all syringes arriving at the fill station are appropriately siliconized, no matter what their manufacturing source, and for end of line inspection for compatibility with auto-injectors before final packaging. The system and methods of the present invention are also applicable to 100 percent high throughput inspection of syringes rather than batch inspection and release.

For example, control parameters related to the distribution of silicone oil along the length of a syringe barrel may be extracted from accumulated to a SPC control chart to justify accept/rejection decisions of syringes during inspection. In this embodiment, syringes having an SPC control parameter, determined after inspection, image processing and image analysis, below a predetermined level may be rejected as being likely to stall with a statistically high degree of confidence. Control parameters that may be used include, but are not limited, distribution of silicone area as a function of syringe barrel position, including a weighted analysis giving more weight to selected locations along the length of the barrel, distribution of silicone oil as a function of both radial position and barrel position, and other pertinent metrics.

In another embodiment, statistical analysis of the results of multiple syringe inspections may be used to determine whether it is necessary to rotate each syringe through 360 degrees to image the entire circumference of the inner wall of the syringe. For example, it may only be necessary to capture less than 360 degrees of the syringe to allow for a high confidence prediction syringe failure due to incomplete injection.

In still another embodiment, high throughput inspection of syringes may be accomplished by using multiple light sources, targets and cameras to eliminate the need to rotate the syringe through 360 degrees. In this manner the entire circumference of the inner wall of the syringe can be imaged without the need to rotate the syringe. The images from the multiple cameras can be stored in a memory and then combined under control of a processor for subsequent analysis.

In yet another embodiment, a line scan digital CCD or CMOS camera can be used. Cameras such as these are capable of scanning one or more lines, and are available from Basler, Cognex and others. Using such a camera, the syringe is rotated continuously through 360 degrees during image capture, eliminating the need to translate the syringe in a direction transverse to the optical axis of the inspection system to ensure that the entire barrel of the syringe is imaged. Such a system is advantageous in that it provides a more rapid inspection while requiring reduced or no mechanical movement of the syringe holding assembly, thus possible eliminating the need for an actuator to move the syringe transversely to the optical axis.

While the above describes various embodiments of the invention with regard to inspection of transparent or semi-transparent articles with cylindrical shapes, such as syringes, vials, ampules, tubing and the like, the invention is not limited to inspection of such articles. For example, the various embodiments of the invention can also be used to inspect any shape that can be inserted into the optical path between the target and camera of the inspection system. For example, an embodiment of the inspection system of the present invention can be used to image defects or contamination present on ovoid, semicircular, oblate, flat or other uniquely shaped transparent or semi-transparent articles.

While the various embodiments of the present invention have been described with reference to the detection and analysis of defects in the distribution of silicone oil in syringes, the system and method will also be applicable to other inspection uses where the ability to detect the occurrence of, and then analyze the distribution of, small, difficult to observe, defects, such as, for example, cracks, airlines, dimples or other container abnormalities, or the presence, absence or distribution of additives, such as, for example, lubricants or release agents and the like, is important. For example, the system and methods of the present invention can also be used to inspect medical grade tubing for defects, inspect for gel contaminants on clear vials, and for the detection of scratches, cracks, airlines, dimples or other container abnormalities on glass or plastic tubing, ampules, or other components, where the components are transparent or semitransparent.

While several particular forms of the invention have been illustrated and described, it will be apparent that various modifications can be made without departing from the spirit and scope of the invention.

We claim:

1. An inspection system for monitoring the distribution of an additive on the inner surface of the barrel of a syringe, comprising:
a target having a pattern of alternating light and dark areas;
a camera in optical alignment with the target;
a syringe holder for holding a syringe at a desired location between the camera and the target; and,
a light source for illuminating the target to enable the camera to capture an image of the target through the syringe.

2. The system of claim 1, wherein the camera is a digital camera, and further comprising a processor and a memory in communication with the digital camera, the memory storing images received from the camera under control of the processor.

3. The system of claim 2, wherein the processor is programmed to receive images from the camera, store the images in the memory, and processes the images to detect the presence of an additive on a portion of an inner wall of the syringe.

4. The system of claim 1, wherein the syringe holder is configured to provide for rotation of the syringe.

5. The system of claim 1, wherein the syringe holder is movably mounted with respect to the target and the camera to provide for translational of the syringe in a direction normal to an alignment axis of the camera and target.

6. The system of claim 1, wherein the light source is positioned behind the target and so that light is transmitted through the light areas of the target towards the camera.

7. The system of claim 1, wherein the light source illuminates a front side of the target such that light illuminating the target is directed towards the camera.

8. The system of claim 3, wherein the additive is silicone oil.

9. The system of claim 3, wherein the processor is further programmed to determine a distribution of the additive as a function of location on the inner wall of the syringe.

10. The system of claim 9, wherein the processor is further programmed to analyze the distribution of the additive as a function of location on the inner wall of the syringe and provide a value representative of the distribution and to determine if the value falls within a range of values representing an acceptable distribution of additive on the inner wall of the syringe.

11. A method for inspecting an article to determine if a surface of the article has an acceptable condition, comprising:
placing the article in a fixture located between a target and a camera;
acquiring an image by the camera of the target through the article;
processing the image of the target to determine if any defects associated with a selected surface of the article are present;
analyzing the image to determine the distribution of defects associated with selected surface of the article; and
rejecting the article if the distribution of defects associated with the selected surface of the article is determined to be unacceptable.

12. The method of claim 11, further comprising storing the acquired image in a memory.

13. The method of claim 12, further comprising:
acquiring a first image by the camera of the target through the article;
storing the first image in the memory;
moving the article a selected amount;
acquiring a second image by the camera of the target through the article;
storing the second image in the memory;
processing the first and second images stored in the memory to provide a composite image of the surface of the article.

14. The method of claim 13, further comprising:
translating the article along an axis transverse to an axis defined by the camera and the target;
acquiring a third image by the camera of the target through the article;
storing the third image in the memory;
processing the first, second and third images stored in the memory to provide a composite image of the surface of the article.

15. A system for determining the distribution of silicone oil on a selected surface of an article, comprising:
a target having a pattern of alternating light and dark areas;
a light source positioned behind the target;
a digital camera positioned to receive light transmitted through the target from the light source;
an article holder for holding an article at a desired location between the camera and the target such that light transmitted through the target from the light source passes through the article to the camera; and
a memory in communication with the camera for storing images from the camera produced by the light passing through the article.

16. The system of claim 15, wherein the article holder is movable to allow movement of the article relative to an optical path defined by the digital camera and the target.

17. The system of claim 16, further comprising a processor in communication with the camera and the memory, the processor programmed to control the storage of images from the camera in the memory, to process the images in the memory, and to analyze the processed images to determine a distribution of silicone oil on a selected surface of the article.

18. The system of claim 17, wherein the processor is also programmed to provide an indication to a user of the acceptability of the distribution of silicone oil on the selected surface of the article.

19. The method of claim 11, wherein the article has central lumen defined by an inner wall.

20. The method of claim 11, wherein the article is an article selected from the group consisting of a vial, a tube, an ampule or a syringe.
